(19) United States
(12) Patent Application Publication
(10) Pub. No.: US 2011/0203864 A1
(43) Pub. Date: Aug. 25, 2011

(54) HOOD ASSEMBLY FOR A LAWN TRACTOR WITH REMOVABLE COWL

(75) Inventors: Stephen J. Ryczek, Hartland, WI (US); Erik R. Slegelis, Port Washington, WI (US); Bruce S. Lydy, Germantown, WI (US); Steven J. Weber, Germantown, WI (US)

(73) Assignee: BRIGGS & STRATTON CORPORATION, Wauwatosa, WI (US)

(21) Appl. No.: 12/712,752

(22) Filed: Feb. 25, 2010

(51) Int. Cl. B62D 25/10; B62D 25/12

(52) U.S. Cl. 180/69.24

(57) ABSTRACT

A hood assembly for a lawn tractor that includes a removable air intake cowl to prevent debris and rain from entering into the open interior defined by the hood. The air intake cowl is removably mounted to the hood of the lawn tractor. The hood of the lawn tractor includes a series of engine intake openings that allow air to flow onto the internal combustion engine. The cowl is defined by a top wall and a pair of depending sidewalls that each include a series of air inlet openings. The air inlet openings extend generally perpendicular to the top panel of the hood and thus prevent debris and rain from reaching the engine intake openings.

### BACKGROUND OF THE INVENTION

The present disclosure generally relates to lawn tractors. More specifically, the present disclosure relates to an air intake system for a lawn tractor.

It is well known in the art of riding lawn tractors to provide ventilation through the hood of the tractor to cool the internal combustion engine during operation. The air pulled through the hood is used not only to cool the engine, but also to mix with the gasoline to create combustible conditions to provide power to the engine. Many currently available lawn tractors include air intake openings formed directly in the top panel of the hood. When such openings are formed in the top panel of the hood, rain and debris can enter into the enclosed area surrounded by the hood, which may cause problems such as rust and/or debris build-up.

### SUMMARY OF THE INVENTION

The present disclosure generally relates to a hood assembly for a lawn tractor. More specifically, the present disclosure relates to a hood assembly that includes a removable cowl that covers a plurality of engine intake openings formed in the hood to prevent debris and rain from entering into the area enclosed by the hood assembly.

The hood assembly includes a hood that has a top panel and a pair of depending side panels that at least partially surround the internal combustion engine. The top panel of the hood includes a plurality of engine intake openings. Typically, the engine intake openings are formed in a horizontal portion of the top panel such that the engine intake openings allow air to flow through the hood and onto the internal combustion engine.

The hood assembly further includes a cowl that is removably mounted to the top panel of the hood to cover the plurality of engine intake openings. In one embodiment, the cowl includes a top wall and a pair of depending sidewalls, where each of the depending sidewalls includes a plurality of air inlet openings. The sidewalls formed as part of the cowl extend generally perpendicular to the top panel of the hood such that the air inlet openings formed in the cowl are generally perpendicular to the engine intake openings formed in the hood.

When the cowl is mounted to the hood, the sidewalls of the cowl space a top wall of the cowl from the top panel of the hood to define an airflow passage. During operation of the internal combustion engine, air flows through the generally vertical air intake openings formed in the cowl and travels through the generally horizontal engine intake openings formed in the top panel of the hood. The top wall of the cowl extends past the engine intake openings to prevent debris and rain from entering directly into the engine intake openings.

In one embodiment of the disclosure, the hood and cowl are formed from different materials. As an example, the hood is formed from a metallic material while the cowl is formed from a molded thermoplastic material.

In one embodiment, the air inlet openings formed in the cowl are generally positioned in alignment with the engine intake openings formed in the hood to facilitate the passage of air through the cowl and through the hood to contact with the internal combustion engine.

Various other features, objects and advantages of the invention will be made apparent from the following description taken together with the drawings.

### BRIEF DESCRIPTION OF THE DRAWINGS

The drawings illustrate the best mode presently contemplated of carrying out the invention. In the drawings:

FIG. 1 is a perspective view of a lawn tractor including the air intake cowl constructed in accordance with the present disclosure;

FIG. 2 is a view of the hood and cowl of the lawn tractor in an exploded condition; and

FIG. 3 is a section view taken along line 3-3 of FIG. 1 illustrating the mounting of the cowl mounted to the hood of the lawn tractor.

### DETAILED DESCRIPTION OF THE PREFERRED EMBODIMENT

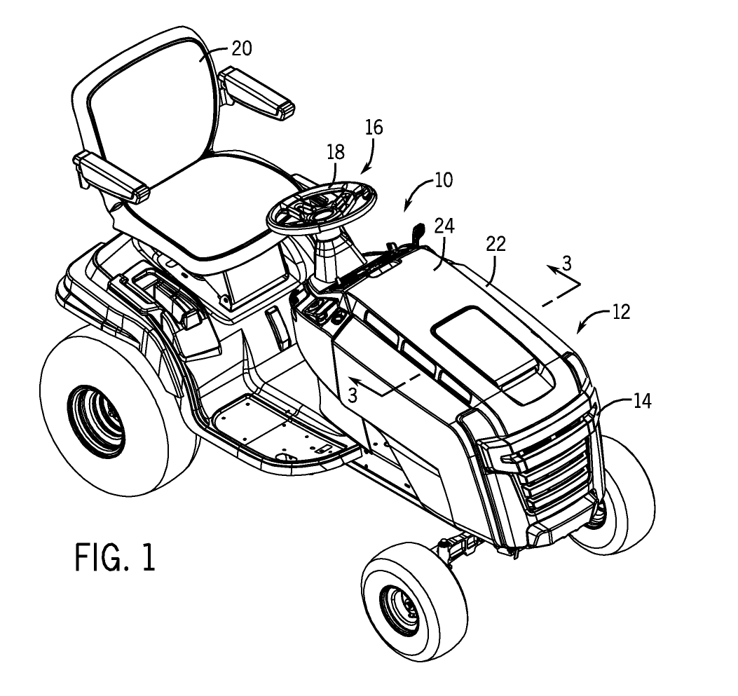

FIG. 1 illustrates a lawn tractor 10 that can be operated by the user in a conventional manner. The lawn tractor 10 is powered by an internal combustion engine (not shown) contained beneath a front hood assembly 12. The front hood assembly 12 is positioned behind a front grill 14 and in front of the steering assembly 16, including the steering wheel 18. As is conventional, an operator positioned on a seat 20 utilizes the steering wheel 18 and other operator controls to control the operation of the internal combustion engine and direct the lawn tractor 10 along a desired path.

The internal combustion engine is enclosed by the hood assembly 12, including a hood 22 and a cowl 24.

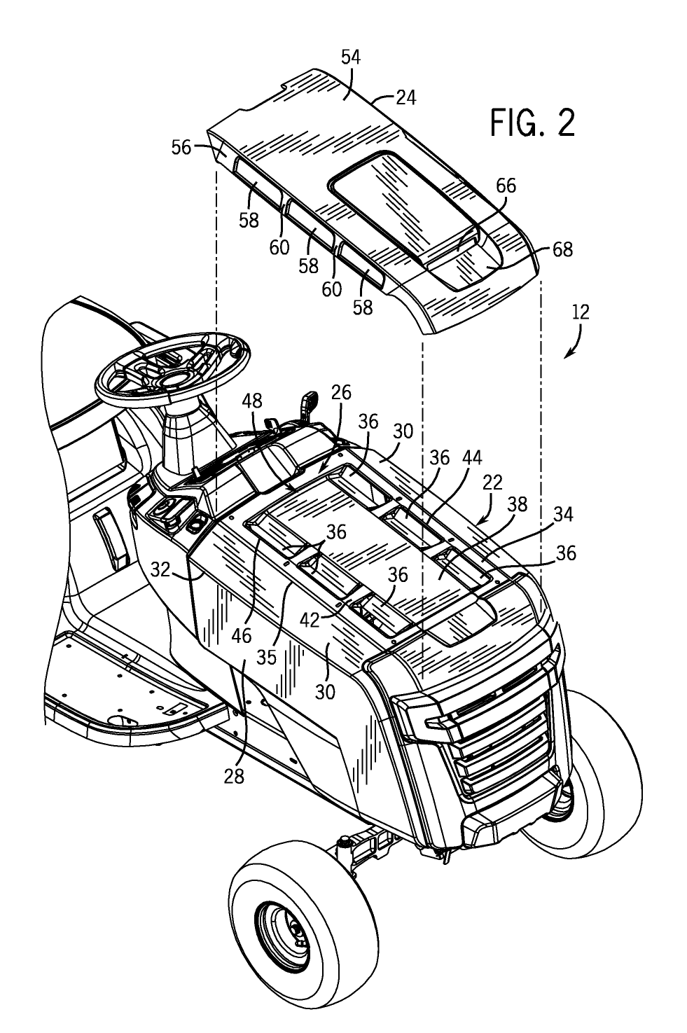

Referring now to FIG. 2, the hood assembly 12 generally includes the removable cowl 24 and the hood 22. The cowl 24 is designed to be formed separate from the hood 22. In the embodiment illustrated, the hood 22 is formed from a metallic material while the cowl 24 is formed from a thermoplastic material. However, it is contemplated that both the cowl 24 and the hood 22 could be formed from other materials while operating within the scope of the present disclosure.

The hood 22 generally includes a top panel 26 that is joined to a pair of side panels 28 to at least partially enclose the internal combustion engine. In the embodiment illustrated, the top panel 26 is a generally planar element while the side panels 28 extend generally perpendicular to the top panel 26. The top panel 26 includes a pair of sloping walls 30 that are joined to each of the side panels 28 along an edge 32. Opposite ends of the sloping walls 30 join with a center section 34 along another edge 35. Throughout the remaining disclosure, the combination of the sloping walls 30 and the center section 34 will be referred to as the top panel 26. The configuration and construction of the sloping walls 30 and the center section 34 can be modified while operating within the scope of the present disclosure.

As illustrated in FIG. 2, the top panel 26 includes a plurality of engine intake openings 36. In the embodiment illustrated, the top panel 26 includes six engine intake openings spaced on opposite sides of a center web 38.

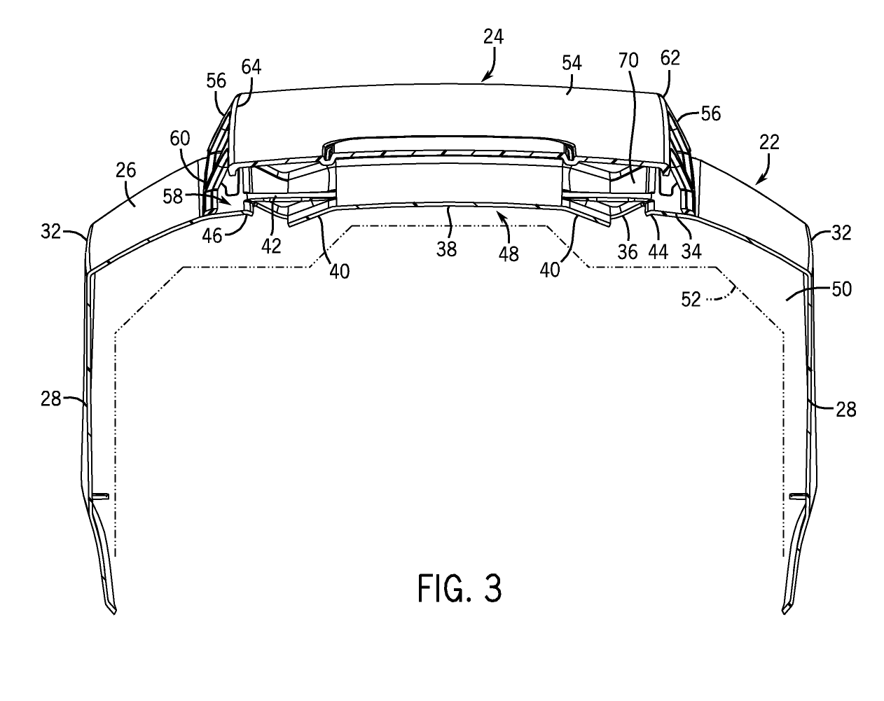

As can be seen in FIG. 3, the center web 38 includes angled outer flanges 40 that extend generally downward from the center web 38. The center web 38 is joined to the remaining portions of the center section 34 by a series of bridges 42. The bridges 42 separate the engine intake openings 36 as illustrated.

Referring back to FIG. 2, the engine intake openings 36 are defined by a first lateral edge 44 and a second lateral edge 46. The first and second lateral edges 44, 46 define the width of the engine air intake section 48. The engine air intake section 48 includes the plurality of engine intake openings 36 and the center web 38.

When the cowl 24 is removed from the hood 22, each of the engine intake openings 36 is exposed. In such a condition, rain and debris, such as leaves, can enter into the open interior 50 including the internal combustion engine 52 shown in FIG. 3. In order to prevent debris and rain from entering into the open interior 50, cowl 24 is mounted to the top panel 26 of the hood 22.

As illustrated in FIG. 2, the cowl 24 includes a top wall 54 and a pair of spaced, depending sidewalls 56. In the embodiment illustrated, each of the sidewalls 56 includes a plurality of air inlet openings 58. The air inlet openings 58 are separated from each other by supporting webs 60.

The three air inlet openings 58 generally correspond in location to the engine intake openings 36 when the cowl 24 is mounted to the hood 22. Although the preferred embodiment includes the same number of air inlet openings 58 formed in the cowl 24 as the number of engine intake openings 36 formed in the hood 22, it is contemplated the different number of air inlet openings 58 could be utilized while operating within the scope of the present disclosure.

As illustrated in FIG. 3, each of the sidewalls 56 extends at an angle relative to the generally planar top wall 54. The top wall 54 has a width extending from a first lateral edge 62 to a second lateral edge 64. As can be seen in FIG. 3, the width of the top wall 54 from the first lateral edge 62 to the second lateral edge 64 is greater than the width of the engine air intake section 48, which extends from the first lateral edge 44 to the second lateral edge 46. As shown in FIG. 3, the top wall 54 of the cowl 24 covers all of the engine intake openings 36 formed in the engine air intake section 48. Thus, the top wall 54 covers the openings 36 to prevent rain and debris from entering directly into the engine intake openings 36.

Referring back to FIG. 2, the top wall of the cowl 24 further includes a top inlet air opening 66. The top inlet air opening 66 is positioned adjacent to a recessed surface 68 such that the top inlet air opening 66 extends generally perpendicular to the top wall 54. The perpendicular arrangement of the top inlet air opening 66 aids in preventing rain and debris from passing through the top wall 54 while allowing air to be drawn into the engine intake openings 36.

Referring back to FIG. 3, when the cowl 24 is mounted to the hood 22, the top wall 54 is spaced above the top panel 26 define an airflow passage 70. The airflow passage 70 allows air to flow through the air inlet openings 58 and subsequently through the series of engine intake openings 36. The space created by the sidewalls 56 allows for a free flow of air while preventing debris and rain from entering through the engine intake openings 36.

In the embodiment illustrated in FIGS. 2 and 3, the cowl 24 simply rests on the top panel 26. However, it is contemplated that the cowl 24 could be attached to the hood 22 using other types of methods, such as removable connectors, posts or grooves. Since the cowl 24 is preferably formed from a material different than the hood 22, ease of assembly is a requirement since the cowl 24 is typically attached to the hood 22 after assembly of the lawn tractor.

We claim:

1. A hood assembly for a lawn tractor powered by an internal combustion engine, comprising:
a hood having a top panel and a pair of depending side panels, the hood positioned to at least partially surround the internal combustion engine;
a plurality of engine intake openings formed in the top panel of the hood; and
a cowl removably mounted to the top panel of the hood to cover the plurality of air intake openings, the cowl having a top wall and a pair of depending sidewalls, wherein each of the sidewalls includes a plurality of air inlet openings.

2. The hood assembly of claim 1 wherein the sidewalls of the cowl are generally perpendicular to the top panel of the hood when the cowl is mounted on the hood.

3. The hood assembly of claim 2 wherein the top wall of the cowl includes a top air inlet opening.

4. The hood assembly of claim 1 wherein the top panel includes the same number of engine intake openings as the number of air inlet openings in the cowl.

5. The hood assembly of claim 1 wherein the hood and the cowl are formed from different materials.

6. The hood assembly of claim 4 wherein each of the engine intake openings are generally aligned with one of the air inlet openings when the cowl is mounted on the hood.

7. The hood assembly of claim 1 wherein the top wall of the cowl extends laterally past the engine intake openings when the cowl is mounted on the hood.

8. A hood assembly for a lawn tractor powered by an internal combustion engine comprising:
a hood for at least partially surrounding the internal combustion engine, the hood including a top panel having a plurality of engine intake openings to allow air flow through the top panel to the internal combustion engine; and
a cowl removably mounted to the hood, the cowl having a top wall and a pair of depending sidewalls, wherein the top wall covers the plurality of engine intake openings when the cowl is mounted to the hood.

9. The hood assembly of claim 8 wherein the top wall is spaced from the top panel by the pair of sidewalls to define an airflow passage between the top wall and the top panel.

10. The hood assembly of claim 8 wherein the sidewalls of the cowl each include a plurality of air inlet openings.

11. The hood assembly of claim 10 wherein the top wall includes at least one top air inlet opening.

12. The hood assembly of claim 10 wherein the sidewalls of the cowl are generally perpendicular to the top panel of the hood such that the plurality of air inlet openings are generally perpendicular to the plurality of engine intake openings.

13. The hood assembly of claim 12 wherein the sidewalls are positioned laterally outward from the plurality of engine intake openings when the cowl is mounted on the hood.

14. The hood assembly of claim 8 wherein the hood and cowl are formed from different materials.

15. The hood assembly of claim 10 wherein the top panel includes the same number of engine intake openings as the number of air inlet openings in the cowl.
